(19) United States
(12) Patent Application Publication
(10) Pub. No.: US 2015/0006632 A1
(43) Pub. Date: Jan. 1, 2015

(54) DETERMINING ADDITIONAL INFORMATION FOR AN INTENDED ACTION OF A USER

(71) Applicant: Google Inc., Mountain View, CA (US)

(72) Inventors: Andrew Tomkins, Menlo Park, CA (US); Tristan Harris, Los Gatos, CA (US); Shanmugasundaram Ravikumar, Berkeley, CA (US); Bo Pang, Sunnyvale, CA (US); Sujith Ravi, Santa Clara, CA (US); Can Sar, Mountain View, CA (US); Angelo DiNardi, Los Gatos, CA (US)

(73) Assignee: Google Inc., Mountain View, CA (US)

(21) Appl. No.: 14/064,888

(22) Filed: Oct. 28, 2013

Related U.S. Application Data
(60) Provisional application No. 61/840,364, filed on Jun. 27, 2013.

(51) Int. Cl. H04L 12/58

(52) U.S. Cl. CPC H04L 51/00
USPC 709/204

(57) ABSTRACT

Methods and apparatus related to receiving user task information indicative of an intended action of a user, determining additional information related to completion of the intended action, determining a completion step for the intended action based on the additional information, and providing the completion step to the user. The user task information may be received from a first source and the additional information may be determined from one or more additional sources that are distinct from the first source. Additional sources may include, for example, user data associated with the user and/or one or more non-user specific databases such as an entity database. Whether a completion step is provided to a user may be dependent on one or more factors such as, for example, the source of the user task information, the source of the additional information, and/or a trigger associated with the completion step.

### CROSS-REFERENCE TO RELATED DOCUMENTS

This application claims the benefit of U.S. Provisional Application No. 61/840,364, filed Jun. 27, 2013, and entitled “Determining Additional Information for an Intended Action of a User,” which is hereby incorporated by reference in its entirety.

### BACKGROUND

This specification is directed generally to determining additional information for an intended action of a user and, more particularly, to determining additional information for an intended action of the user and determining a suggested completion step for the intended action based on the determined additional information.

A user may be associated with a task that that is indicative of one or more actions the user intends to perform. For example, a user may be associated with a task to pay a bill from a cell phone company that is indicative of an intended action of paying the cell phone bill that the user intends to perform. The user may need to perform one or more steps to complete the task. For example, the user may need to access an on-line bill payment webpage of the cell phone company to pay the cell phone bill.

### SUMMARY

The present disclosure is directed to methods and apparatus for receiving user task information indicative of an intended action of a user, determining additional information related to completion of the intended action, determining a completion step for the intended action based on the additional information, and providing the completion step to the user. In some implementations the user task information may be received from a first source and the additional information may be determined from one or more additional sources that are distinct from the first source. Additional sources may include, for example, one or more documents associated with the user and/or one or more non-user specific databases such as an entity database. Whether a completion step is provided to a user may be dependent on one or more factors such as, for example, the source of the user task information, the source of the additional information, and/or a trigger associated with the completion step.

In some implementations, a method is provided that includes the steps of: receiving user task information, the user task information indicative of an intended action of a user; determining additional information related to completion of the intended action of the user, the additional information being information that is in addition to the received user task information; determining a suggested completion step for the intended action based on the additional information; and providing the suggested completion step for the intended action to the user.

This method and other implementations of technology disclosed herein may each optionally include one or more of the following features.

The method may further include the step of identifying a task type for the intended action of the user, and the step of determining the additional information related to completion of the intended action of the user may be based on the identified task type. The task type may be based on a format of the user task information. The task type may include at least one of a product purchase task, a product cancellation task, a contact task, and an appointment task.

The method may further include the steps of: identifying at least one entity associated with the user task information; and determining the additional information based on the identified entity. The additional information may include contact information of the identified entity. The additional information may include a geographic location of the identified entity. The additional information may include operating hours for the identified entity.

The method may further include the step of determining the additional information based on user data associated with the user. The user data may include at least one of the user contacts, user webpage navigation history, and user e-mails. The method may further include the step of identifying a task type for the intended action of the user, and determining the additional information may be based on the identified task type.

The method may further include the step of determining a source of the user task information, and the step of providing the additional information to the user as a suggested completion step for the intended action may be dependent on the source of the user task information. The step of providing the suggested completion step for the intended action may occur only when the source of the information is a trusted source. The trusted source may include a user, a personal contact of the user, and/or a trusted task generating business entity.

The method may further include the steps of determining occurrence of a trigger for the step of providing the suggested completion step for the intended action; and providing the suggested completion step to the user in response to occurrence of the trigger. The trigger may be determining presence of the user in a geographic location proximal to a geographic location in which the suggested completion step may be completed. The trigger may be determining that the current time is a time included in the additional information, the time being associated with the suggested completion step. The time may be based on a deadline for performing the intended action. The method may further include the step of identifying at least one entity associated with the intended action and determining the time based on operating hours of the identified entity.

Other implementations may include a non-transitory computer readable storage medium storing instructions executable by a processor to perform a method such as one or more of the methods described herein. Yet another implementation may include a system including memory and one or more processors operable to execute instructions, stored in the memory, to perform a method such as one or more of the methods described herein.

Particular implementations of the subject matter described herein determine additional information related to completion of an intended action of a user. The additional information may be associated with the intended action of the user and represents a new aspect of the intended action. Particular implementations of the subject matter described herein may additionally and/or alternatively determine a suggested completion step for the intended action based on the additional information. The suggested completion step represents a new aspect of the intended action. Particular implementations of the subject matter described herein may additionally and/or alternatively provide the suggested completion step to the user based on one or more criteria. The providing of the suggested completion step and/or the criteria upon which such providing is based represent new aspects of the intended action.

It should be appreciated that all combinations of the foregoing concepts and additional concepts discussed in greater detail herein are contemplated as being part of the inventive subject matter disclosed herein. For example, all combinations of claimed subject matter appearing at the end of this disclosure are contemplated as being part of the inventive subject matter disclosed herein.

### BRIEF DESCRIPTION OF THE DRAWINGS

FIG. 1 is a block diagram of an example environment in which a method of determining additional information for an intended action of a user and determining a suggested completion step for the intended action based on the determined additional information may be implemented.

FIG. 2 is a flow chart illustrating an example method of determining additional information for an intended action of a user and determining a suggested completion step for the intended action based on the determined additional information.

FIG. 3 is a flow chart illustrating an example method of determining additional information based on an entity that is identified based on user task information.

FIG. 4A is an illustration of a task entry user interface via which a user may enter user task information.

FIG. 4B is an illustration of an example mapping between terms of the user task information entered in the task information user interface of FIG. 4A and a task type; a mapping between the task type and task information fields is also illustrated.

FIG. 4C is an illustration of an example e-mail of a user from which additional information may be determined.

FIG. 4D is an illustration of an example mapping between an entity and properties of the entity from which additional information may be determined.

FIG. 5 is an example graphical user interface to provide a user with a suggested completion step.

FIG. 6 illustrates a block diagram of an example computer system.

### DETAILED DESCRIPTION

Generally, the present disclosure is directed to methods and apparatus for receiving user task information indicative of an intended action of a user, determining additional information related to completion of the intended action, determining a completion step for the intended action based on the additional information, and providing the completion step to the user.

As one example, user task information may be received based on a message sent to the user from a user's friend Walt that invites the user to an upcoming surprise birthday party for a mutual friend Jesse. For example, the message may be an e-mail message from an invite service that includes a subject of “Surprise Birthday Party for Jesse” and includes text in the body of the e-mail stating “You′re invited to a surprise Birthday party for Jesse at Restaurant A next Tuesday at 7:00. Please let Walt know if you will be attending by this Friday”. At least some of the text of the e-mail may be the user task information and is indicative of the intended action of attending Jesse's birthday party.

Additional information may be determined that is related to completion of the intended action of attending Jesse's birthday party. For example, it may be determined from the text in the body of the e-mail that Jesse's birthday party is at Restaurant A and additional information related to navigating to Restaurant A may be determined, such as an address of Restaurant A and/or one or more transportation options for navigating to Restaurant A. The address and/or transportation options may be obtained from one or more additional sources unique from the e-mail such as, for example, one or more databases such as those described herein. Also, for example, it may be determined from the text in the body of the e-mail that the user needs to let Walt know if he will be attending and contact information for Walt may be determined such as a phone number for Walt and/or an e-mail address for Walt. The phone number and/or e-mail address may be obtained from one or more additional sources unique from the e-mail such as, for example, another e-mail of the user that was sent from Walt and/or a contacts list of the user that includes an e-mail address and/or phone number for Walt.

One or more suggested completion steps may be determined for the intended action of attending Jesse's birthday party based on the additional information. For example, a suggested completion step of contacting Walt utilizing the phone number and/or e-mail address for Walt may be determined. Also, for example, a suggested completion step of obtaining directions to Restaurant A and/or obtaining a listing of public transportation options for navigating to Restaurant A may be determined. One or more determined suggested completion steps for the intended action of attending Jesse's birthday party may be provided to the user. For example, a suggested completion step of e-mailing Walt to confirm that the user will be attending may be provided to the user. Also, for example, directions to Restaurant A may be provided to the user.

In some implementations, the one or more suggested completion steps may be provided based on the occurrence of one or more triggers. For example, the suggested completion step of e-mailing Walt to confirm that the user will be attending may be provided in response to the trigger of the user accessing an e-mail application. Also, for example, the suggested completion step of e-mailing Walt to confirm that the user will be attending may be provided in response to the trigger of the user selecting an option to compose a new message within an e-mail application. Also, for example, the suggested completion step of e-mailing Walt to confirm that the user will be attending may be provided in response to the trigger of the user composing a new message to Walt within an e-mail application. For example, in response to the user entering Walt's e-mail address in a “To:” field of an e-mail, the user may be presented with the option to auto-fill the subject and/or the body of the e-mail with text indicating confirmation of the user's anticipated attendance at the birthday party (e.g., “Walt: Wanted to let you know that I plan to attend Jesse's surprise birthday party at Restaurant A”). Also, for example, the suggested completion step of providing directions to restaurant A may be provided in response to a time-based trigger, such as providing directions to restaurant A one hour prior to the birthday party (at 6:00 next Tuesday). Also, for example, the suggested completion step of providing directions to restaurant A may be provided in response to a location-based trigger, such as providing directions to restaurant A based on location data of the user indicating the user has begun to travel somewhere shortly before the scheduled time for the party. Also, for example, the suggested completion step of providing directions to restaurant A may be provided based on location data of the user indicating the user is in a car shortly before the scheduled time for the party (e.g., based on identifying pairing of the user's mobile phone with a communications system of the car via Bluetooth or other communications protocol).

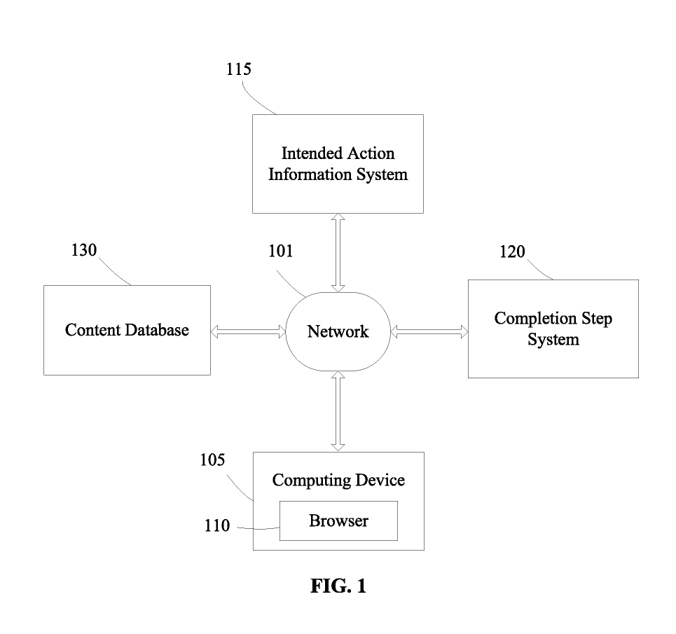

Referring to FIG. 1, a block diagram of an example environment is illustrated in which a method of determining additional information for a user task and determining a suggested completion step related to the user task based on the determined additional information may be implemented. The environment includes computing device 105, an intended action information system 115, a completion step system 120, and a content database 130. The environment also includes a communication network 101 that enables communication between various components of the environment.

The computing device 105 executes one or more applications and may be, for example, a desktop computer, a laptop computer, a cellular phone, a smartphone, a personal digital assistant (PDA), a tablet computer, a navigation system, a wearable computing device (e.g., glasses, watch, earpiece), and/or other computing device. The computing device 105 includes memory for storage of data and software applications, a processor for accessing data and executing applications, and components that facilitate communication over a communication network 101. In some implementations the computing device 105 may include hardware that shares one or more characteristics with the example computer system that is illustrated in FIG. 6. In some implementations, the one or more applications executed by the computing device 105 may include a web browser 110. As discussed herein, the computing device 105 may optionally be utilized to, directly or indirectly, identify an intended action of a user, provide user task information and/or additional information, to identify occurrence of a trigger for a suggested completion step, and/or to receive a suggested completion step. The web browser 110 may be utilized to access one or more applications discussed herein such as, for example, e-mail applications, calendar applications, and/or task applications. Such one or more applications may alternatively be accessed via other applications executing on the computing device 105 and/or may be executed at least in part by the computing device 105. The operations performed by the computing device 105 may optionally be distributed across multiple computer systems.

The computing device 105 may further include hardware and/or software that may be utilized to determine location data indicative of the location of the computing device 105. For example, location data may be identified based on, for example, GPS and/or estimation of the location of the computing device 105 via cellular signals, Wi-Fi signals, and/or other radio-frequency (RF) signals. In some implementations, the computing device 105 may include one or more location sensors. For example, location sensors may include a GPS device and/or an RF transmitter and/or receiver to enable identification of the location of the computing device 105. Any estimation of the location of the computing device 105 via RF and/or other signals may be made by the computing device 105 directly and/or via other computing devices. Also, for example, location data of the computing device 105 may be based on check-ins via the computing device, other user indicated visits to locations via the computing device 105, and/or interaction with other computing devices via the computing device 105. For example, location data may be based on a check-in to a location via the computing device 105 and may be indicative of the location of the computing device 105 and its associated user. Also, for example, location data may be based on communication between the computing device 105 and one or more other computing devices having a location property and the location may be based on such location property. For example, pairing of the computing device 105 with a computing device of a vehicle may be indicative of the user being located in a vehicle.

The term “check-in”, as used herein, includes a user-approved and/or user-initiated indication of a visit to a location. For example, a user at a Location A may be provided, via a mobile computing device, with an option to verify that the user is at Location A. For example, the option to verify may be in the form of a prompt provided to the user, such as, for example, “Would you like to check-in to your current location?” along with a list of selectable options including “Location A”, “Location B”, and “Location C”. The user may select “Location A” in response to the prompt to check-in to Location A. Also, for example, a user may choose to automatically check-in to one or more locations visited by the user. For example, locational data may indicate that the user is at Location A, and the user, via a mobile computing device, may automatically check-in to Location A. Additional and/or alternative techniques to check-in to a geographical location may be utilized.

The content database 130 may include one or more storage mediums. For example, in some implementations, the content database 130 may include multiple computer servers each containing one or more storage mediums. Information discussed herein may optionally be stored in the content database 130 and/or an additional database. For example user task information, additional information, task type, and/or a suggested completion step may be stored in content database 130 for later access by one or more components. Also, for example, one or more documents utilized to determine user task information, additional information, and/or a suggested completion step may be stored in the content database 130. For example, the content database 130 may include one or more documents that may be accessed by the intended action information system 115 via communication network 101. For the purposes of this specification, a document is any data that is associated with a document address. Documents include webpages, word processing documents, portable document format (PDF) documents, images, video, audio, e-mails, calendar entries, task entries, and feed sources, to name just a few. The documents may include content such as, for example, words, phrases, pictures, audio, task identifiers, entity identifiers, etc.; embedded information (such as meta information and/or hyperlinks); and/or embedded instructions (such as JavaScript scripts). In this specification, the term “database” will be used broadly to refer to any collection of data. The data of the database does not need to be structured in any particular way, or structured at all, and it can be stored on storage devices in one or more locations. Thus, for example, the database may include multiple collections of data, each of which may be organized and accessed differently.

In some implementations, the content database 130 may include an entity database such as a knowledge graph. For example, content database 130 may include a mapping (e.g., data defining an association) between entities and one or more properties and/or other entities related to the entity. In some implementations, entities are topics of discourse. In some implementations, entities are persons, places, concepts, and/or things that can be referred to by a text fragment (e.g., a term or phrase) and are distinguishable from one another (e.g., based on context). For example, the text “bush” in a query or on a webpage may potentially refer to multiple entities such as President George Herbert Walker Bush, President George Walker Bush, a shrub, and the rock band Bush. In some implementations, an entity may be referenced by a unique entity identifier that may be used to identify the entity. The unique entity identifier may be associated with one or more properties associated with the entity and/or with other entities. For example, in some implementations, the entity database may include properties associated with unique identifiers of one or more entities. For example, a unique identifier for the entity associated with the airport with an airport code “LAX” may be associated with a name or alias property of “LAX,” another alias property of “Los Angeles International Airport” (an alternative name by which LAX is often referenced), a phone number property, an address property, and/or an entity type property of “airport” in the entity properties database. Additional and/or alternative properties may be associated with an entity in one or more databases

Intended action information system 115 may receive user task information indicative of an intended action of a user and determine additional information related to completion of the intended action. In some implementations intended action information system 115 may receive user task information that has already been associated with a user. For example, intended action information system 115 may access content database 130 to identify user task information that has been previously associated with the user. For example, the content database 130 may include, for a given user, one or more tasks that are each indicative of an intended action of the user and that are each associated with user task information. For example, a user may be associated with a task that is indicative of a user action to pay a cell phone bill and that is associated with user task information including the amount of the cell phone bill and the company associated with the cell phone bill. Also, for example, a user may be associated with a task that is indicative of a user action to purchase a book that is associated with user task information including the author of the book. Also, for example, a user may be associated with a task that is indicative of a user action to book a trip that is associated with user task information including the destination city, departure date, and return date.

In some implementations, intended action information system 115 may determine user task information based on one or more documents associated with a user and/or one or more actions of a user. For example, user task information may be determined based on one or more documents of the user. For example, an e-mail sent by the user and/or an e-mail received by the user may be utilized to determine user task information. For example, an e-mail may be received that is a reminder from a service provider that informs a user that the user's service contract with the service provider is coming up for renewal. In such an example, the intended action may be a service renewal decision and the user task information may include the service provider and/or information about the service contract. Also, for example, a text message sent by the user and/or an e-mail received by the user may be utilized to determine user task information. For example, a text message may be received from a friend of the user that invites the user to an event at a venue. In such an example, the intended action may be attending the event and the user task information may include the event and/or the venue.

Also, for example, user task information may be determined based on one or more explicit user inputs from the user. For example, the user may create a calendar entry on a certain date and at a certain time with the text “Dentist Appointment”. In such an example, the intended action may be an appointment and the user task information may include the date, the time, and that the appointment is a “dentist” appointment. Also, for example, the user may create a task entry of “Schedule dentist appointment” associated with a target completion date. In such an example, the intended action may be to schedule an appointment and the user task information may include the target completion date and that the appointment is a “dentist” appointment. Also, for example, the user may provide spoken input that includes “Dentist appointment next Tuesday at 1:00”. In such an example, the intended action may be an appointment and the user task information may include the date, the time, and that the appointment is a “dentist” appointment. Also, for example, the user may select a task from a provided list of task suggestions. For example, a user may be provided with a selection of task suggestions based on partial input that is entered by the user, and the user may select one or more of the task suggestions to associate the intended action indicated by the task suggestion and user task information associated with the task suggestion with the user. For example, the user may enter the partial input “pay c” in a field such as a task entry field, a search query field, and/or a calendar entry field. A task suggestion of “pay cell phone bill” may be provided in response to the partial query and, upon selection of the task suggestion, the intended action of paying a bill may be associated with the user and the user task information of the bill being a cell phone bill. Task suggestions for the partial query may be identified, for example, based on a database of task suggestions (e.g., prefix based matching).

Also, for example, user task information may be determined based on one or more actions of the user. For example, the user may call a plurality of phone numbers within a relatively short time frame. For example, the user may call a plurality of restaurants to attempt to obtain a reservation at a certain time, or may call a number of service providers to obtain price quotes and/or additional information about a service. In such an example, the intended action may be to contact an entity and the user task information may include the called phone numbers. The called phone numbers and/or the intended action may be supplied by a computing device of the user such as a mobile phone utilized to call the phone numbers. Also, for example, the user may purchase a product. For example, the user may purchase a product that involves relatively complex installation and/or assembly endeavors. In such an example, the intended action may be to use the purchased product and the user task information may include an identifier of the purchased product. The purchased product and/or the intended action may be determined, for example, via transaction information in purchasing the product and/or via an e-mailed receipt indicating purchase of the product. Also, for example, a user may navigate to multiple webpages providing reviews on a particular product. In such an example, the intended action may be to purchase the particular product and the user task information may include an identifier of the particular product.

As another example, a user may access a search engine via browser 110, and terms that are entered as a search query may be utilized by the intended action information system 115 to identify user task information indicative of an intended action of the user. For example, the terms that are entered by the user may be provided to the intended action information system 115 only when one or more key terms are identified in the search query. For example, terms may only be provided when the term “Task:” is provided as the predicate in a search query. In such a situation one or more terms that are provided after “Task:” may be utilized to determine user task information indicative of an intended action of the user entering the query. For example, if a user enters the query “Task: pay my cell phone bill”, the intended action may be to pay a bill and the user task information may identify that the bill is a cell phone bill. Also, for example, key terms may additionally and/or alternatively include other terms indicative of an intended user action besides “Task:”, such as “pay my,” “cancel my,” “remind me to”, and/or “schedule”.

Also, for example, user task information may be determined based on location data provided via one or more computing devices of the user. For example, location data may indicate that the user just landed in a new city. In such an example, the intended action may be to perform an action in the new city (e.g., call a cab, find a rental car) and the user task information may include the location data and/or an identifier of the new city. Also, for example, location data may indicate that the user arrived at a transportation hub (e.g., a train stop). In such an example, the intended action may be to travel to a destination utilizing one or more modes of transportation provided at the transportation hub and the provided information may include the location data and/or an identifier of the transportation hub.

In some implementations, user task information may be associated with a user based on explicit task input from the user. For example, a user may provide input related to one or more tasks of a user via one or more applications accessed via computing device 105. For example, the user may access a task application via computing device 105 that enables entry and management of user tasks and, utilizing the task application, the user may provide input that includes user task information related to one or more tasks.

Additional and/or alternative sources for receiving user task information indicative of an intended action of a user may be utilized. Moreover, although receiving user task information based on documents and/or one or more user actions in the preceding examples, it is understood that one or more documents and one or more actions may both be utilized in some scenarios. For example, user task information may be determined based on one or more documents of the user, but may require affirmative user input confirming that such user task information is correct.

In some implementations, user task information may include and/or be indicative of a task type that is indicative of the nature of the intended action. The intended action information system 115 may determine the task type based on the user task information. For example, user task information may be indicative of the intended action of traveling to an appointment and the user task information may include an explicit indication that the task is of an “appointment” task type. Also, for example, user task information may be indicative of an intended action of completing a product purchase and the user task information that is included with the user task information (e.g., product type, target date for purchase) may indicate that the task if of a “product purchase” task type. Further examples of task types include, for example, “service cancellation”, “travel reservation”, and/or “contact”. Additional and/or alternative task types may be provided, including task types of greater or less granularity of description. Moreover, in some implementations user task information may be indicative of multiple potential task types. For example, provided user task information may be ambiguous and indicative of a task type of “product purchase” and a task type of “service renewal”. As described herein, in some implementations determined additional information that is related to the intended action indicated by the user task information may be utilized to determine one or more suggested completion steps for an appropriate single task type when multiple ambiguous task types are provided.

In some implementations, a user may specifically identify a task type. For example, if multiple task types for an intended action are determined, the user may be provided with the option to select one of the multiple task types for associating with the intended action. Also, for example, in performing a user action that results in determined user task information, the user may input terms that explicitly identify a task type. For example, the user may include the terms “appointment task:” or “Task type: appointment” in submitting a search query via an application that is executing on computing device 105.

In some implementations, the source of the user task information may be indicative of a task type. For example, user task information that is determined by the intended action information system 115 based on information from a calendar application may be more likely to be of a task type of “appointment”. Also, for example, the sender of an e-mail utilized to determine user task information may be utilized to determine the task type. For example, if the sender of the e-mail is an entity that is focused on travel reservations, the task type may be “travel reservation”. Also, for example, if the sender of the e-mail is associated with the air travel division of the entity that is focused on travel reservations, the task type may be “airline travel reservation”. Also, for example, if user task information indicative of an intended meeting is identified based on an e-mail, the task type may be “personal meeting” if the sender of the e-mail is a personal friend of the user (e.g., as determined from the user's contacts), but may be a “business meeting” if the sender is a business contact of the user (e.g., as determined from the user's contacts).

In some implementations, the task type may be determined based on the format of the user task information in the source of the user task information. For example, car reservation (“car reservation” task type) e-mails from one or more trip booking companies may have a first format with first characteristics, whereas flight reservation (“flight reservation” task type) e-mails from the one or more companies may have a second format with second characteristics. For example, user task information may be identified from an e-mail that is from “Airline”, has a subject heading of “Flight Information”, and includes the terms “Departure” and “Returning” in the body of the email. Based at least on such formatting, it may be determined that the task type is a “flight reservation”.

In some implementations, the intended action information system 115 may determine a task type based on mappings between multiple entities and/or mappings between entities and one or more entity properties. The intended action information system 115 may identify the entities and/or entity properties via accessing one or more database such as an entity database. For example, an entity database may include one or more knowledge graphs mapping entities and entity properties and/or entities and other entities. In some implementations intended action information system 115 may determine one or more task types based on mappings between multiple entities and/or entities and entity properties, in combination with artificial intelligence having predictive capabilities. For example, in some implementations one or more mappings between two or more entities may define relationships between the entities that may be utilized to determine a task type. For example, a calendar entry may include user task information that includes the terms “call Business A”. Based on the terms, an entity associated with “Business A” and an entity associated with the concept of “calling” may be identified. The two entities may be mapped together via one or more task types that may connect the two entities such as, for example, the task type of “appointment”. For example, the task type “appointment” may be mapped to the entity associated Business A as a task type that may be performed with Business A and mapped to the entity associated with “calling” as a task type that may be performed by the act of calling. Based on such a mapping, it may be predicted that the task type indicated by the user task information is “appointment”.

Also, for example, a calendar entry may include the text “cancel with Business A” and/or a spoken input by a user may be identified as “cancel with Business A”. The terms “cancel” may indicate an intended cancellation action and the text “Business 1” may indicate the intended cancellation action is related to an entity associated with “Business 1”. A mapping between an entity associated with “Business 1” and properties of that entity may indicate that the entity is a service entity. Based on such a mapping, the task type may be determined to be “service cancellation”. Additional and/or alternative methods of identifying task types based on mappings between multiple entities and/or entities and properties in combination with artificial intelligence having predictive capabilities may be utilized.

Intended action information system 115 may further determine additional information related to completion of the intended action. The additional information is in addition to any information related to completion of the intended action that is included in the received user task information. Additional information that is related to completion of a user task may be determined from one or more sources. In some implementations the sources may include sources that are unique from the one or more sources utilized to determine the user task information. For example, if the user task information was determined based on an e-mail received by a user, the sources may include other e-mails, an entity database, and/or a contacts list of the user. Sources may include, for example, e-mails of a user, entries in a calendar application of a user, contacts of a user, internet or other navigational history of the user, other documents that are associated with the user, attributes of the user (e.g., age, location, occupation), and/or one or more databases such as an entity database.

In some implementations, a navigational history of a user may be based on a record of one or more indications of actions taken by a user via one or more computing devices. The actions may include, for example, search queries submitted by a user to an Internet search engine, user selections of search results provided by the search engine, resources selected and/or visited by the user, and so on. A “selection” of the search result or the resource may include, for example, a mouse-click, a click-through, a voice-based selection, a selection by a user's finger on a presence-sensitive input mechanism (e.g., a touch-screen device), and/or any other appropriate selection mechanism.

In some implementations, additional information may only be identified from sources that are determined to be trusted sources. For example, one or more databases such as an entity database may be determined to be trusted sources. Also, for example, a user's e-mails may be identified to be a trusted source. In some implementations only a subset of documents and/or other data from a source may be identified as trusted. For example, only e-mails that are sent by contacts of a user may be identified as trusted e-mails. Also, for example, an e-mail that is sent by a cellular phone company, even if the cellular phone company is not a listed contact of the user, may be determined to be a trusted e-mail based on other information indicating the user currently has a contract with the cellular phone company.

In some implementations, the intended action information system 115 may determine additional information that is related to the completion of the intended action from one or more non-user-specific databases such as an entity database. For example, user task information that includes the service provider for an intended action of a service renewal decision may be determined from an e-mail received by a user. Additional information related to the service renewal decision may include a phone number and/or webpage of the service provider that may be called to renew and/or cancel the service and may be determined via one or more databases. For example, an entity associated with the service provider may be identified in an entity database and may be mapped to a contact phone number and a webpage of the entity.

Also, for example, user task information that includes an event and a venue for the event for an intended action of attending an event may be determined from a text message received by a user. Additional information related to attending the event may include an address for the venue and/or a date and time for the event and may be determined via one or more databases. For example, an entity associated with the venue may be identified in an entity database and may be mapped to an address associated with the venue. Also, for example, an entity associated with the event may be identified in the entity database and may be mapped to the entity associated with the venue. The mapping between the venue and the event may define properties of the event at the venue such as, for example, the date and time of the event at the venue.

Also, for example, user task information that includes a plurality of phone numbers called by a user may be determined based on the user calling the plurality of phone numbers within a relatively short time frame and may be indicative of an intended action to contact one or more entities via phone. Additional information related to contacting one or more entities via phone may include additional phone numbers that are similar to the plurality of phone numbers called and may be determined via one or more databases. For example, for each of the phone numbers, an entity associated with the phone number may be identified and one or more common mappings of such entities may be utilized to determine additional phone numbers that are similar to the plurality of phone numbers called. For example, each of the phone numbers may be associated with an entity that is mapped to an entity type of “restaurant”, mapped to a property of “fine dining”, and mapped to a location of “City”. Based on such mappings, additional entities that are also an entity type of “restaurant”, mapped to a property of “fine dining”, and mapped to a location of “City” may be determined. Phone numbers associated with such entities may be identified as the additional information.

Also, for example, user task information that includes a name of a dental office and a completion date may be determined based on a user task entry and may be indicative of an intended action to schedule an appointment with the dental office. Additional information related to scheduling the appointment may include a phone number for the dental office and operating days and hours for the dental office and may be determined based on one or more databases. For example, the entity associated with the dental office may be identified in an entity database and may be mapped to properties that include a phone number, operating hours, and operating days.

Also, for example, user task information may be received that includes the terms “call Business 1” and is indicative of a user action to call Business 1. Based on the terms, an entity associated with “Business 1” and an entity associated with the concept of “calling” may be identified. The two entities may be mapped together via the phone number that may be called to reach Business 1. For example, the phone number may be mapped to the entity associated with Business 1 as a property of Business 1 and mapped to the entity associated with “calling” as a function that may be performed with the phone number. Based on such a mapping, it may be predicted that the phone number is additional information that is relevant for the user task information “call Business 1”.

In some implementations, the intended action information system 115 may determine additional information that is related to the completion of the intended action from one or more documents that are associated with the user, such as documents stored in content database 130 and/or locally on computing device 105. For example, user task information that includes the service provider for an intended action of a service renewal decision may be determined from a task entry of a user. Additional information related to the service renewal decision may include a phone number and/or webpage of the service provider that may be called to renew and/or cancel the service and may be determined via one or more documents associated with the user. For example, an e-mail received from the service provider may be identified in the user's e-mail based on the indication of the service provider in the user task information (e.g., via keyword matching) and the phone number and/or webpage of the service provider that may be called to renew and/or cancel the service may be determined from the e-mail. For example, the e-mail may include the terms “To renew your service please contact us at 123-456-7890 or visit www.example.com/renew”.

Also, for example, user task information that includes an event and a venue for the event for an intended action of attending an event may be determined from a text message received by a user. Additional information related to attending the event may include an address for the venue and/or a date and time for the event and may be determined via one or more documents associated with the user. For example, the user's navigation history may include a visit to a webpage associated with the event and may be identified based on the indication of the event in the user task information (e.g., based on searching the user's navigation history based on the event) and the webpage may include an address of the venue at which the event will be held and the date and time of the event at the venue.

Also, for example, user task information that includes a name of a dental office and a completion date may be determined based on a user task entry and may be indicative of an intended action to schedule an appointment with the dental office. Additional information related to scheduling the appointment may include a phone number for the dental office and may be determined based on one or more documents associated with the user. For example, a contacts list of the user may include a listing for the dental office that includes the phone number for the dental office.

Also, for example, user task information that includes the terms “flight on Friday” may be determined based on a user task entry and may be indicative of an intended action to take a flight on Monday. Additional information related to taking the flight on Monday may include information related to the time of the flight, the airport from which the flight departs, etc. and may be determined based on one or more documents associated with the user. For example, an e-mail of the user from the content database that includes flight confirmation information for a flight on Monday may be identified and information from the identified email utilized to determine additional information about the flight, such as flight times, destination, and/or departure airport information.

In some implementations, the intended action information system 115 may determine additional information that is related to the completion of the intended action utilizing both one or more non-user specific databases and user documents. For example, user task information that includes “schedule dentist appointment”, but does not specifically identify a dentist may be determined based on a user task entry and may be indicative of an intended action to schedule an appointment with the dental office. Additional information related to scheduling the appointment may include a phone number for the dental office and operating hours for the dental office. A contacts list of the user may include a listing for “Dentist” and a phone number. Based on the listing, it may be determined that the phone number corresponds to the user's dentist. The phone number may be utilized to determine the name of the dentist and the office hours via one or more non-user specific databases. For example, the phone number may be mapped to an entity associated with a dentist office in an entity database and an “alias” property mapped to the entity may be utilized as the name and operating hours may also be determined that are mapped to the entity.

In some implementations, the intended action information system 115 may utilize the intended action of which the user task information is indicative in determining additional information. For example, as described herein, in some implementations a task type may be determined for the intended action of the user. For example, the task type may be received with the user task information and/or may be determined based on the user task information. In such implementations the task type may be indicative of the intended action of the user and utilized to determine the additional information. For example, for a task type of “schedule appointment” the intended action information system 115 may determine that certain additional information is needed for such task type. For example, the task type “schedule appointment” may be mapped to a plurality of determined information fields that may be useful in determining suggested completion steps for that task type. For example, the task type “schedule appointment” may be mapped to information fields such as “phone number for scheduling” and “operating hours of entity with which appointment is to be scheduled”. The intended action information system 115 may determine that provided user task information includes information pertaining to “phone number for scheduling”, but does not include information pertaining to “operating hours of entity with which appointment is scheduled”. Based on such determination, the intended action information system 115 may determine that the additional information that should be determined is the operating hours of the entity with which the appointment is to be scheduled.

As another example, a task type of “attend event” may be mapped to a plurality of determined information fields that may be useful in determining suggested completion steps for that task type. For example, the task type “attend event” may be mapped to information fields such as “venue for event”, “address for venue”, and “date for event”. The intended action information system 115 may determine that provided user task information includes information pertaining to “venue for event” and “date for event”, but does not include information pertaining to “address for venue”. Based on such determination, the intended action information system 115 may determine that the additional information that should be determined is the address for the venue.

Also, for example, user task information may be received that includes the terms “cancel service with Business 1” and is indicative of a user action to cancel service with Business 1. The user task information may be received, for example, via a task entry of a user and/or via spoken input provided by the user. The terms “cancel service” may indicate an intended action of service cancellation and the text “Business 1” may indicate the service cancellation is related to an entity associated with “Business 1”. An intended action of service cancellation may be associated with certain properties associated with an entity such as, for example, one or more phone numbers that may be called to cancel service, one or more e-mail addresses that enable cancellation of service, and/or one or more webpages that enable cancellation of service. A mapping between an entity associated with “Business 1” and properties of that entity that may indicate one or more phone numbers related to that entity that may be called to cancel service, one or more e-mail addresses related to that entity that enable cancellation of service, and/or one or more webpages related to that entity that enable cancellation of service may be identified and utilized as additional information. For example, a webpage that enables cancellation of service and is mapped to the entity associated with “Business 1” may be identified as additional information. Additional and/or alternative methods of identifying additional information based on mappings between multiple entities and/or entities and properties, optionally in combination with artificial intelligence having predictive capabilities may be utilized.

In some implementations, additional information may be determined based on characteristics of a user that are associated with the user. Characteristics may include age group, geographic location, and personal preferences (e.g., musical preferences, literary preferences), to name a few. In some implementations, characteristics may be associated with a user based on user entry of the information. In some implementations, one or more characteristics may be associated with the user based on determined information. For example, the literary preferences of a user may be determined by one or more applications based on the genre of eBooks that were previously purchased by the user.

Completion step system 120 may determine one or more suggested completion steps for the intended action based on the additional information identified by the intended action information system 115 and may provide the suggested completion steps to the user. The suggested completion steps may be one or more actions that are related to the intended action and may need to be performed by the user to complete the intended action. The suggested completion steps may be provided to the user via one or more computing devices associated with the user. For example, the suggested completion steps may be provided via one or more applications executing on a computing device of the user. In some implementations, the suggested completion steps may be provided to the user in response to the occurrence of a trigger. For example, a suggested completion step may be provided in response to a user action via a computing device (e.g., unlocking the computing device, accessing one or more applications, issuing a search query), user location data received via a computing device (e.g., location data indicating user is near a location where the suggested completion step may be completed), and/or time (e.g., based on a deadline for performing the intended action and/or operating hours of an entity associated with the intended action).

For example, user task information that includes the service provider for an intended action of a service renewal decision may be determined from an e-mail received by a user. Additional information related to the service renewal decision may be determined that includes a phone number that may be called to renew the service and operating hours for the service provided. The suggested completion step may be to call the phone number during the operating hours. The suggested completion step may be provided to the user via one or more computing devices associated with the user. For example, the suggested completion step may be provided to a mobile phone of the user via a graphical user interface (GUI) that informs the user to call the service provider and lists the operating hours of the service provider and/or via a GUI that provides the option to call the service provider and that is provided during the operating hours of the service provider. In some implementations the suggested completion step may be provided in response to the occurrence of one or more triggers. For example, in some implementations the suggested completion step may be provided in response to one or more actions via the mobile phone such as unlocking the mobile phone, accessing a phone dialing application of the mobile phone, accessing a phone dialing application of the mobile phone and entering one or more digits in the phone number that may be called to renew the service, and/or issuing a search query and/or entering a partial query that is related to the intended action (e.g., issuing a search query for “contact information of service provider”). Also, for example, in some implementations the suggested completion step may be provided in response to occurrence of one or more times associated with the additional completion step such as operating hours of the service provider and/or a deadline that may be provided for renewing the service contract.

Also, for example, user task information that includes a product to purchase for an intended action of purchasing the product may be determined based on task input of a user. Additional information related to the intended action of purchasing the product may be determined that includes a retail store at which the product may be purchased and operating hours of the retail store. The suggested completion step may be to go to the retail store during the operating hours to purchase the product. The suggested completion step may be provided to the user via one or more computing devices associated with the user. For example, the suggested completion step may be provided to a mobile phone of the user via a mapping application executed on the mobile phone that informs the user the retail location is nearby and carries the product to be purchased. In some implementations, the suggested completion step may be provided in response to the occurrence of one or more triggers. For example, in some implementations the suggested completion step may be provided in response to one or more actions via the mobile phone such as accessing a mapping application of the mobile phone, accessing a mapping application of the mobile phone and searching for the product to be purchased and/or the retail location via the mapping application, and/or accessing a mapping application and viewing a geographic area that includes the retail store. Also, for example, in some implementations the suggested completion step may be provided in response to occurrence of one or more times associated with the additional completion step such as operating hours of the service provider and/or a deadline that may be provided for purchasing the product. Also, for example, in some implementations the suggested completion step may be provided in response to location data associated with the user, such as utilizing the location data to determine presence of the user in a geographic location proximal to the retail location.

Also, for example, user task information that includes a plurality of phone numbers called by a user may be determined based on the user calling the plurality of phone numbers within a relatively short time frame and may be indicative of an intended action to contact one or more entities via phone. Additional information related to contacting the entities via phone may be determined that includes one or more additional phone numbers that are similar to the plurality of phone numbers. The suggested completion step may be to call one or more of the additional phone numbers. The suggested completion step may be provided to the user via one or more computing devices associated with the user. For example, the suggested completion step may be provided to a mobile phone of the user by presenting information about entities related to the phone numbers and offering the option for the user to call one or more of the entities. In some implementations the suggested completion step may be provided in response to the occurrence of one or more triggers such as those discussed herein.

Also, for example, user task information may be determined based on location data provided via one or more computing devices of the user. For example, location data may indicate that the user just landed in a new city and the intended action may be to obtain transportation. Additional information related to obtaining transportation may be determined that includes one or more phone numbers for cabs in the new city. The suggested completion step may be to call one or more of the phone numbers for cabs and may be provided to the user via one or more computing devices associated with the user. In some implementations the suggested completion step may be provided in response to the occurrence of one or more triggers such as those discussed herein.

Also, for example, location data may indicate that the user just arrived at bus stop and the intended action may be to travel to a destination utilizing one or more bus routes available at the bus stop. Additional information related to traveling to the destination may be determined that includes the destination (e.g., based on a destination determined via a venue provided in a calendar entry of the user) and a bus route that will enable the user to travel to the destination. The suggested completion step may be to travel to the destination utilizing the bus route and may be provided to the user via one or more computing devices associated with the user. In some implementations the suggested completion step may be provided in response to the occurrence of one or more triggers such as those discussed herein.

In some implementations, the completion step system 120 may utilize the intended action of which the user task information is indicative in determining the suggested completion step. For example, as described herein, in some implementations a task type may be determined for the intended action of the user. For example, for a task type of “schedule appointment” the completion step system 120 may determine that one or more types of suggested completion steps are appropriate for such a task type. For example, the task type “schedule appointment” may be mapped to a plurality of determined suggested completion steps such as “Call phone number associated with entity with which appointment is to be scheduled”, “Visit webpage at which appointment may be scheduled”, and/or “Visit location at which appointment may be scheduled”. The determined suggested completion steps may be tailored to the intended action of the user by incorporating user task information and/or additional information as appropriate. For example, a determined suggested completion step of “Call phone number associated with entity with which appointment is to be scheduled” may be tailored to include an actual phone number and an actual entity determined as described herein (e.g., via user task information and/or additional information).

In some implementations, the completion step system 120 may utilize mappings between provided user task information and/or determined additional information in determining the suggested completion step. For example, user task information may be received that includes the terms “cancel service with Business 1” and is indicative of an intended action to cancel service with Business 1. The user task information may be received, for example, via a task entry of a user such as spoken input provided by the user. Based on the terms, an entity associated with “Business 1” and an entity associated with the concept of “cancelling service” may be identified. The two entities may be mapped together via one or more suggested completion steps that may be performed to cancel service with “Business 1”. For example, the entities may be mapped together with a suggested completion step of calling a service cancellation number to cancel service and/or visiting a webpage to cancel service.

When multiple completion steps are mapped to a task type and/or mapped between entities, which of one or more completion steps is utilized may be based on one or more factors such as, for example, a ranking associated with the completion steps, the particular user task information and/or additional information that has been determined, the computing device to which the completion step is to be provided, and/or an application via which the completion step will be provided. For example, sufficient information may only be available for one of the suggested completion steps and that suggested completion step may be utilized. Also, for example, it may be more desirable to provide certain suggested completion steps to certain computing devices. For example, in some implementations if the user is utilizing a desktop computing device a suggested completion step that involves navigating to a webpage may be more likely to be utilized than a suggested completion step that involves calling a phone number. Also, for example, it may be more desirable to provide certain suggested completion steps to certain applications. For example, in some implementations if the user is utilizing a mapping application a suggested completion step that involves obtaining directions to a location may be more likely to be utilized.

In some implementations whether a suggested completion step is provided to a user may be based on the source of received user task information. For example, in some implementations suggested completion steps may only be provided when the source of the received user task information is a trusted source. For example, e-mails that are sent by contacts of a user may be identified as a trusted source. Also, for example, an e-mail that is sent by a cellular phone company, even if the cellular phone company is not a listed contact of the user, may be determined to be a trusted e-mail based on other information indicating the user currently has a contract with the cellular phone company. Also, for example, text messages that are sent by contacts of a user may be identified as trusted sources.

In situations in which the systems discussed herein collect personal information about users, or may make use of personal information, the users may be provided with an opportunity to control whether programs or features collect user information (e.g., information about a user's social network, social actions or activities, profession, a user's preferences, or a user's current geographic location), or to control whether and/or how to receive content from the content server that may be more relevant to the user. Also, certain data may be treated in one or more ways before it is stored or used, so that personal identifiable information is removed. For example, a user's identity may be treated so that no personal identifiable information can be determined for the user, or a user's geographic location may be generalized where geographic location information is obtained (such as to a city, ZIP code, or state level), so that a particular geographic location of a user cannot be determined. Thus, the user may have control over how information is collected about the user and/or used.

Many other configurations are possible having more or less components than the environment shown in FIG. 1. For example, although the components are each illustrated alone in FIG. 1, it is understood that the intended action information system 115 and/or completion step system 120 may optionally be combined with one another and/or with one or more of the other components of FIG. 1.

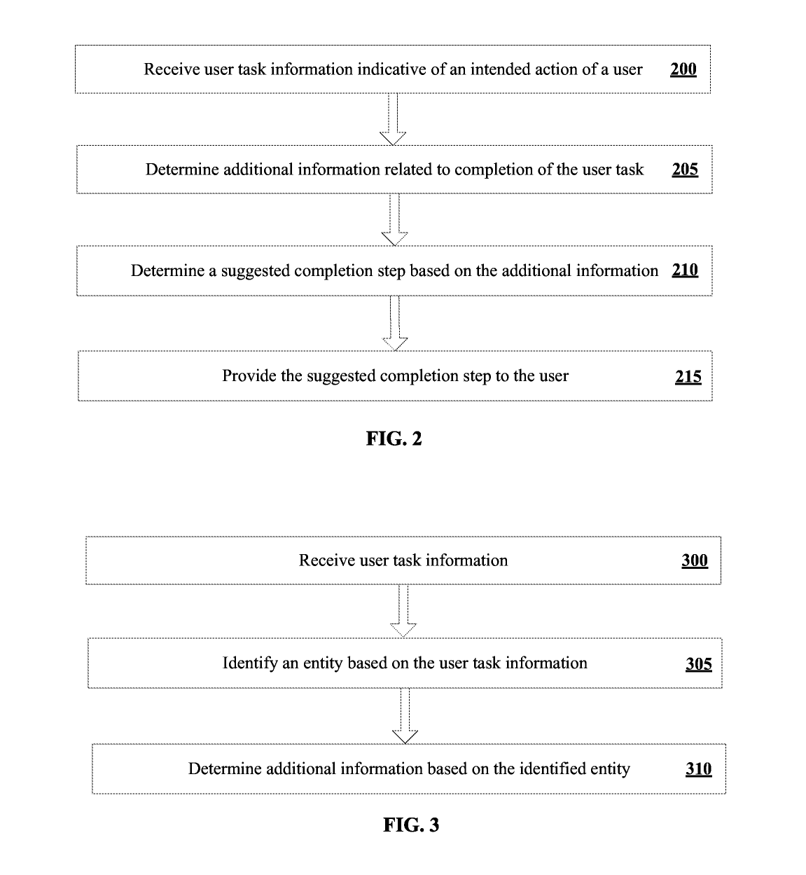

Referring to FIG. 2, a flow chart illustrating an example method of providing a completion step to a user based on user task information and additional information related to the intended action of the user is provided. Other implementations may perform the steps in a different order, omit certain steps, and/or perform different and/or additional steps than those illustrated in FIG. 2. For convenience, aspects of FIG. 2 will be described with reference to one or more components of FIG. 1 that may perform the method such as the intended action information system 115 and/or completion step system 120.

At step 200, user task information indicative of an intended action of a user is received. The user task information may be received by a component that shares one or more characteristics with the intended action information system 115. In some implementations, the user task information may be based on one or more aspects of a document that is associated with a user, such as an e-mail, calendar application entry, and/or webpage that the user has viewed. For example, a user may receive a text message inviting the user to an event and the user task information may include one or more terms of the text message. In some implementations, the user task information may be based on one or more user actions of a user, such as numbers dialed by a user, travel to a location by the user, etc. For example, a user may travel to a location and location data from the user at the location may be utilized as the user task information.

In some implementations, the user task information may include and/or be indicative of a task type that is indicative of the intended action of the user. For example, user task information may include and/or be indicative of a “purchase item” task type that indicates that the user task information is associated with an intended action of a user to purchase an item. In some implementations, a task type may be determined by the intended action information system 115 based on the provided user task information.

At step 205, additional information that is related to the completion of the user task is determined. The additional information may be determined by the intended action information system 115. The additional information may be determined from one or more documents that are associated with the user and/or from one or more non-user-specific sources. For example, additional information may be identified from e-mails of a user, webpages that have been visited by the user, information from one or more applications that have been accessed by the user, and/or other information that has been associated with the user. Also, for example, additional information may be identified from one or more non-user-specific databases such as an entity database. For example, user task information may include a business name of “Business1” for an intended action of scheduling an appointment and intended action information system 115 may identify an entity in an entity database that has an alias of “Business1.” Additional information system 120 may determine additional information from one or more properties that are associated with the “Business1” entity, such as a phone number associated with “Business1” and operating hours of “Business1”. In some implementations step 205 may include one or more of steps 305 and 310 of FIG. 3.

As discussed herein, in some implementations the determined additional information may be based on a task type that is associated with the user task information and that is indicative of an intended action of the user. For example, a task type may be mapped to certain information fields that are related to the task type and the additional information determined may be based on those certain information fields for which user task information is not provided. Also, as discussed herein, in some implementations the additional information determined at step 205 may be determined from one or more sources that are unique from one or more sources of the user task information received at step 200. For example, the user task information may be received from an e-mail of a user and the additional information may be obtained from one or more additional sources unique from the e-mail such as, for example, a different e-mail and/or one or more databases such as those described herein.

At step 210, a suggested completion step is determined based on the additional information that was determined at step 205. In some implementations, the suggested completion step may be determined by a component that shares one or more characteristics with completion step system 120. In some implementations, the suggested completion step may be determined based on the task type optionally identified at step 200 and/or mappings between provided user task information and/or determined additional information.

At step 215, the suggested completion step that was determined at step 210 is provided to the user. The suggested completion step may be provided to the user by a module sharing one or more characteristics with completion step system 120, and may be provided to the user via computing device 105 utilizing communication network 101. In some implementations, the suggested completion step may only be provided upon the occurrence of one or more triggers. Triggers may include, for example, actions via a mobile computing device and/or occurrence of one or more times associated with the suggested completion step.

Referring to FIG. 3, a flow chart illustrating an example method of determining additional information based on an entity that is identified based on user task information is provided. Other implementations may perform the steps in a different order, omit certain steps, and/or perform different and/or additional steps than those illustrated in FIG. 3. For convenience, aspects of FIG. 3 will be described with reference to one or more components of FIG. 1 that may perform the method such as the intended action information system 115.

At step 300, user task information is received. The user task information may be received by a component that shares one or more characteristics with the intended action information system 115. In some implementations, the user task information may be based on one or more aspects of a document that is associated with a user, such as an e-mail, calendar application entry, and/or webpage that the user has viewed. In some implementations, the user task information may be based on one or more user actions of a user, such as numbers dialed by a user, travel to a location by the user, etc. Step 200 may share one or more aspects in common with step 200 of FIG. 2.

At step 305, an entity is identified based on the user task information. For example, user task information may be received via an e-mail sent to a user and may include the text “party at VenueA”. An entity associated with “VenueA” may be identified via one or more databases such as an entity database (e.g., by identifying an entity having an alias property of “VenueA”) and/or via one or more documents and/or actions of the user such as a contacts list of the user, other e-mails of the user, location data of the user, etc. Also, for example, user task information may be received via a phone dialing application of the user and may include the phone numbers dialed via the phone dialing application. It may be determined that the phone numbers dialed via the phone dialing application are all mapped to common entity type and entity location in an entity database. An additional entity may be determined that is also mapped to the common entity type and entity location in the entity database.

At step 310, additional information is determined based on the identified entity. For example, for the entity associated with “VenueA” an address of the entity may be determined. The address may be determined via one or more databases such as an entity database (e.g., by identifying an address property of the entity having an alias property of “VenueA”) and/or via one or more documents of the user such as a contacts list of the user, other e-mails of the user, etc. Also, for example, for the additional entity determined based on the phone numbers dialed via the phone application, a phone number of the additional entity may be determined.

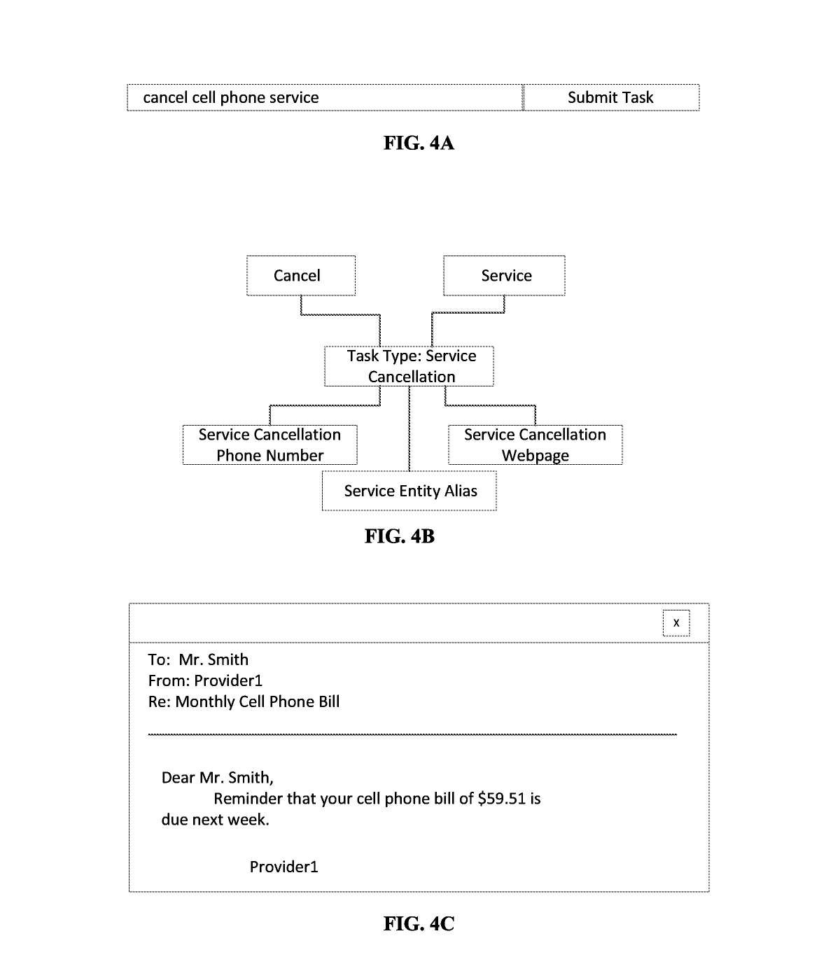

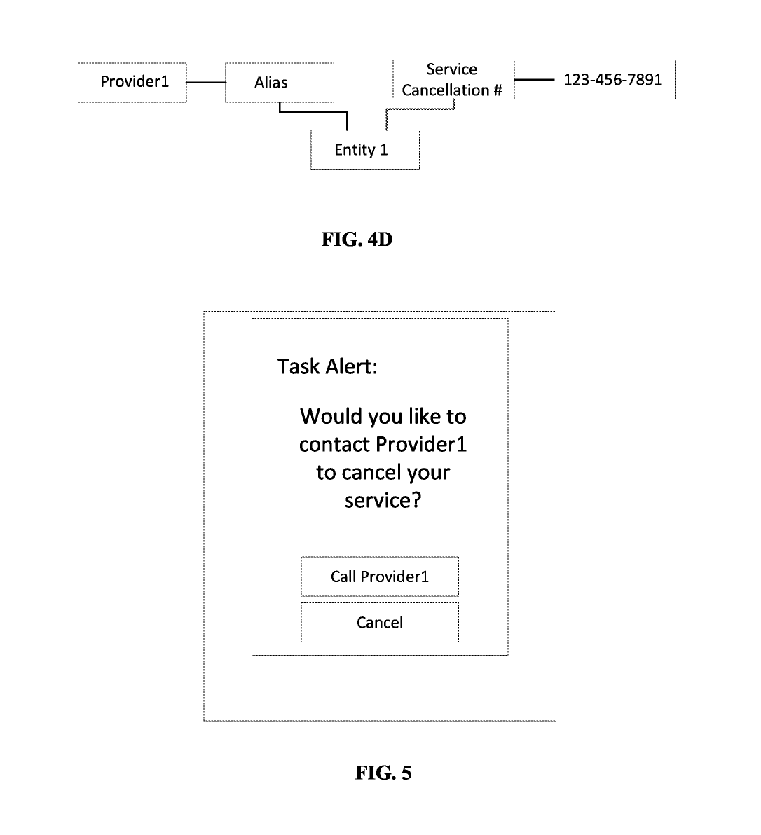

Referring to FIG. 4A, an illustration of a task entry user interface via which a user may enter user task information is provided. The task entry user interface is provided with a user entry field within which the terms “cancel cell phone service” have been entered. A “Submit Task” user interface element is also illustrated. A user may select the “Submit Task” user interface element to submit the terms “cancel cell phone service” as user task information. The intended action information system 115 may receive the user task information.

Based on the received user task information, the intended action information system 115 may determine a task type. For example, the intended action information system 115 may determine a task type based on one or more terms of the user task information. For example, referring to FIG. 4B, an illustration of an example mapping between terms of the user task information entered in the task information user interface of FIG. 4 and a task type is illustrated. The terms “cancel” and “service” are mapped to the task type “Service Cancellation”. Based on such a mapping, it may be determined that the user task information submitted via the user interface of FIG. 4A is of a “service cancellation” task type. Based on the task type, the intended action information system 115 may determine one or more information fields that may be utilized in determining a suggested completion step for that task type. For example, the intended action information system 115 may determine the information fields based on the mapping between the task type and task information fields also illustrated in FIG. 4B. For example, the task type “service cancellation” is mapped to the information fields of “Service Cancellation Phone Number”, “Service Entity Alias”, and “Service Cancellation Webpage”. Such information fields may represent information that may be utilized in determining a suggested completion step.

The intended action information system 115 may determine additional information for such one or more information fields from one or more sources. For example, with reference to FIG. 4C an illustration of an example e-mail of a user from which additional information may be determined is illustrated. The e-mail is from a cell phone provider “Provider1” of the user as indicated by the “From:” field and the body of the e-mail. The e-mail may be utilized to determine that the “Service Entity Alias” is “Provider1”. The e-mail may be determined to be relevant to such a determination based on, for example, the presence of user task information “cell phone” in the e-mail (e.g., in the “Re:” field and the body of the e-mail). Also, for example, with reference to FIG. 4D, an illustration of an example mapping between an entity and properties of the entity from which additional information may be determined is illustrated. The intended action information system 115 may utilize the mapping of FIG. 4D to determine additional information related to the “Service Cancellation Phone Number” information field. For example, based on the determined alias of “Provider1”, it may be determined that “Provider1” is an alias for “Entity1”. It may further be determined that “Entity 1” is mapped to a “Service Cancellation Phone Number” of “123-456-7891”. Thus, based on the e-mail of FIG. 4C and the mapping of FIG. 4D, the intended action information system 115 may determine additional information for the “Service Entity Alias” and “Service Cancelation Phone Number” information fields. Based on such determined additional information, a suggested completion step of calling the entity to cancel the service may be provided to a user.

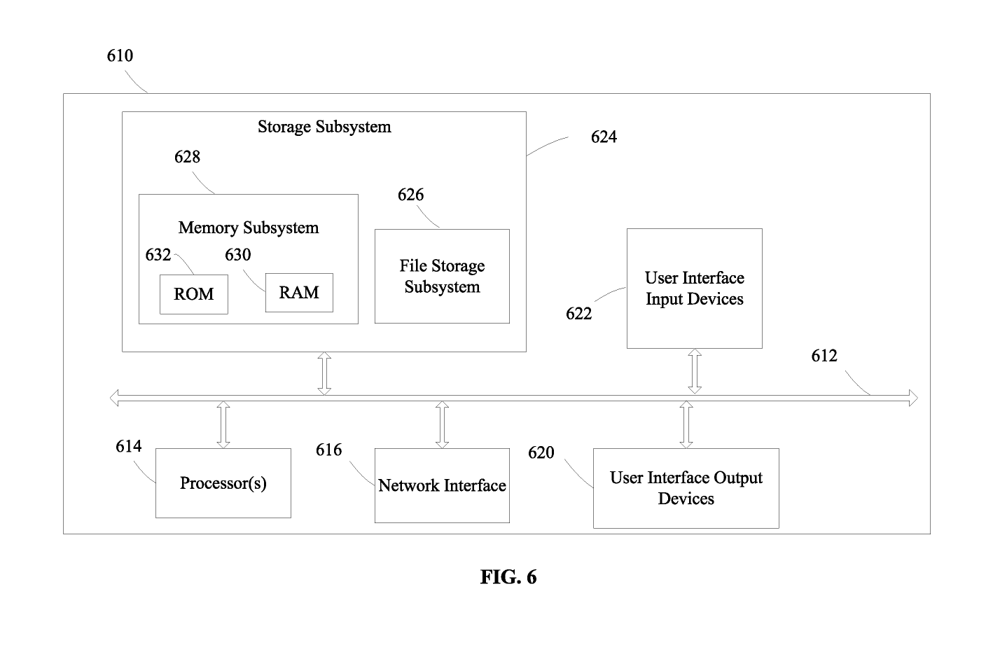

For example, with reference to FIG. 5, an example graphical user interface to provide a user with a suggested completion step is illustrated. The suggested completion step asks the user if he would like to contact Provider1 to cancel his service. The user is presented with the option to “Call Provider1” or to “Cancel”. Selecting “Call Provider1” may initiate a phone dialing application (on the computing device providing the graphical user interface of FIG. 5 or another computing device of the user) and cause the phone dialing application to dial the phone number identified from the mapping of FIG. 4D. Selecting “Cancel” may lead to dismissal of the suggested completion step. The suggested completion step of FIG. 5 is based on the additional information identified from the e-mail of FIG. 4C and the mapping of FIG. 4D. For example, the suggested completion step includes the alias “Provider1” identified from the e-mail of FIG. 4C and enables dialing of the phone number identified from the mapping of FIG. 4D.

FIG. 6 is a block diagram of an example computer system 610. Computer system 610 typically includes at least one processor 614 which communicates with a number of peripheral devices via bus subsystem 612. These peripheral devices may include a storage subsystem 624, including, for example, a memory subsystem 626 and a file storage subsystem 628, user interface input devices 622, user interface output devices 620, and a network interface subsystem 616. The input and output devices allow user interaction with computer system 610. Network interface subsystem 616 provides an interface to outside networks and is coupled to corresponding interface devices in other computer systems.

User interface input devices 622 may include a keyboard, pointing devices such as a mouse, trackball, touchpad, or graphics tablet, a scanner, a touchscreen incorporated into the display, audio input devices such as voice recognition systems, microphones, and/or other types of input devices. In general, use of the term “input device” is intended to include all possible types of devices and ways to input information into computer system 610 or onto a communication network.

User interface output devices 620 may include a display subsystem, a printer, a fax machine, or non-visual displays such as audio output devices. The display subsystem may include a cathode ray tube (CRT), a flat-panel device such as a liquid crystal display (LCD), a projection device, or some other mechanism for creating a visible image. The display subsystem may also provide non-visual display such as via audio output devices. In general, use of the term “output device” is intended to include all possible types of devices and ways to output information from computer system 610 to the user or to another machine or computer system.

Storage subsystem 624 stores programming and data constructs that provide the functionality of some or all of the modules described herein. For example, the storage subsystem 624 may include the logic to determine additional information for an intended action of the user. These software modules are generally executed by processor 614 alone or in combination with other processors. Memory 626 used in the storage subsystem can include a number of memories including a main random access memory (RAM) 630 for storage of instructions and data during program execution and a read only memory (ROM) 632 in which fixed instructions are stored. A file storage subsystem 628 can provide persistent storage for program and data files, and may include a hard disk drive, a floppy disk drive along with associated removable media, a CD-ROM drive, an optical drive, or removable media cartridges. The modules implementing the functionality of certain implementations may be stored by file storage subsystem 628 in the storage subsystem 624, or in other machines accessible by the processor(s) 614.

Bus subsystem 612 provides a mechanism for letting the various components and subsystems of computer system 610 communicate with each other as intended. Although bus subsystem 612 is shown schematically as a single bus, alternative implementations of the bus subsystem may use multiple busses.

Computer system 610 can be of varying types including a workstation, server, computing cluster, blade server, server farm, or any other data processing system or computing device. Due to the ever-changing nature of computers and networks, the description of computer system 610 depicted in FIG. 6 is intended only as a specific example for purposes of illustrating some implementations. Many other configurations of computer system 610 are possible having more or fewer components than the computer system depicted in FIG. 6.

While several inventive implementations have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the inventive implementations described herein. More generally, those skilled in the art will readily appreciate that all parameters, dimensions, materials, and configurations described herein are meant to be exemplary and that the actual parameters, dimensions, materials, and/or configurations will depend upon the specific application or applications for which the inventive teachings is/are used. Those skilled in the art will recognize, or be able to ascertain using no more than routine experimentation, many equivalents to the specific inventive implementations described herein. It is, therefore, to be understood that the foregoing implementations are presented by way of example only and that, within the scope of the appended claims and equivalents thereto, inventive implementations may be practiced otherwise than as specifically described and claimed. Inventive implementations of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the inventive scope of the present disclosure.

All definitions, as defined and used herein, should be understood to control over vocabulary definitions, definitions in documents incorporated by reference, and/or ordinary meanings of the defined terms.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one implementation, to A only (optionally including elements other than B); in another implementation, to B only (optionally including elements other than A); in yet another implementation, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one implementation, to at least one, optionally including more than one, A, with no B present (and optionally including elements other than B); in another implementation, to at least one, optionally including more than one, B, with no A present (and optionally including elements other than A); in yet another implementation, to at least one, optionally including more than one, A, and at least one, optionally including more than one, B (and optionally including other elements); etc.

It should also be understood that, unless clearly indicated to the contrary, in any methods claimed herein that include more than one step or act, the order of the steps or acts of the method is not necessarily limited to the order in which the steps or acts of the method are recited.

What is claimed is:

1. A method, comprising:
receiving user task information, the user task information indicative of an intended action of a user;
determining additional information related to completion of the intended action of the user, the additional information being information that is in addition to the received user task information;
determining a suggested completion step for the intended action based on the additional information; and
providing the suggested completion step for the intended action to the user.

2. The method of claim 1, further comprising identifying a task type for the intended action of the user, wherein determining the additional information related to completion of the intended action of the user is based on the identified task type.

3. The method of claim 2, wherein the task type is based on a format of the user task information.

4. The method of claim 2, wherein the task type includes at least one of a product purchase task, a product cancellation task, a contact task, and an appointment task.

5. The method of claim 1, further comprising:
identifying at least one entity associated with the user task information; and
determining the additional information based on the identified entity.

6. The method of claim 5, wherein the additional information includes one of contact information of the identified entity, a geographic location of the identified entity, and operating hours for the identified entity.

7. The method of claim 1, further comprising determining the additional information based on user data associated with the user.

8. The method of claim 7, further comprising identifying a task type for the intended action of the user, wherein determining the additional information is based on the identified task type.

9. The method of claim 1, further comprising:
determining a source of the user task information,
wherein the step of providing the additional information to the user as a suggested completion step for the intended action is dependent on the source of the user task information.

10. The method of claim 9, wherein the step of providing the suggested completion step for the intended action only occurs when the source of the information is a trusted source.

11. The method of claim 1, further comprising:
determining occurrence of a trigger for the step of providing the suggested completion step for the intended action; and
providing the suggested completion step to the user in response to occurrence of the trigger.

12. The method of claim 11, wherein the trigger is determining presence of the user in a geographic location proximal to a geographic location in which the suggested completion step may be completed.

13. The method of claim 11, wherein the trigger is determining that the current time is a time included in the additional information, the time being associated with the suggested completion step.

14. The method of claim 13, wherein the time is based on a deadline for performing the intended action.

15. The method of claim 13, further comprising identifying at least one entity associated with the intended action and determining the time based on operating hours of the identified entity.

16. A system including memory and one or more processors operable to execute instructions stored in memory, comprising instructions to:
receive user task information, the user task information indicative of an intended action of a user;
determine additional information related to completion of the intended action of the user, the additional information being information that is in addition to the received user task information;
determine a suggested completion step for the intended action based on the additional information; and
provide the suggested completion step for the intended action to the user.

17. The system of claim 16, wherein the instructions further include instructions to:
identify a task type for the intended action of the user,
wherein the additional information related to completion of the intended action of the user is determined based on the identified task type.

18. The system of claim 16, wherein the instructions further include instructions to:
determine a source of the user task information, wherein the additional information to the user as a suggested completion step for the intended action is provided dependent on the source of the user task information.

19. The system of claim 18, wherein the instructions to provide the suggested completion step for the intended action execute only when the source of the information is a trusted source.

20. The system of claim 16, wherein the instructions further include instructions to:
determine occurrence of a trigger for the instruction to provide the suggested completion step for the intended action; and
provide the suggested completion step to the user in response to occurrence of the trigger.

21. The system of claim 20, wherein the trigger is a determined presence of the user in a geographic location proximal to a geographic location in which the suggested completion step may be completed.

22. The system of claim 21, wherein the instructions further include instructions to:
identify at least one entity associated with the user task information; and
determine the additional information based on the identified entity.

23. The system of claim 22, wherein the additional information includes one of contact information of the identified entity, a geographic location of the identified entity, and operating hours for the identified entity.
